(19) United States
(12) Patent Application Publication
(10) Pub. No.: US 2021/0076789 A1
(43) Pub. Date: Mar. 18, 2021

(54) ENHANCED GAMING CHIPS

(71) Applicant: GAMING PARTNERS INTERNATIONAL USA, INC., Las Vegas, NV (US)

(72) Inventors: Miguel RIVERA, Las Vegas, NV (US); Emmanuel GELINOTTE, Las Vegas, NV (US); Christophe LIBOI, Las Vegas, NV (US); Regis VICAIRE, Las Vegas, NV (US)

(21) Appl. No.: 16/961,824

(22) PCT Filed: Jan. 12, 2018
(86) PCT No.: PCT/US2018/013481

§ 371 Date: Jul. 13, 2020

(51) Int. Cl. A44C 21/00; B29C 45/16; G06K 19/07; G06K 19/04

(52) U.S. Cl. CPC A44C 21/00; B29C 45/1671; B29C 2045/14852; G06K 19/047; G06K 19/0723

(57) ABSTRACT

Disclosed is a gaming chip and method of manufacturing the gaining chip. The gaming chip can include a chip component with one or more affixing points. A clip insert can be coupled to the one or more affixing points. A second component can be injected to prevent the clip insert from being removed from the chip component.

### BACKGROUND

Casino currencies can be made of various materials. Casino currencies can include gaming chips. A gaming chip is a token used in lieu of currency in Casinos. The chips can include colored metal, injection-molded plastics, and compressed molded clay. The chips can correspond to various denominations. Typically, chips are used primarily in table games. Groups of chips can have the same weight, which can facilitate counting the chips in bulk.

Money can be exchanged for chips at a Casino. For example, a patron can convert the money into chips at a casino cage, a gaming table, or a cashier station. The chips can be converted back into money when the patron desires. The use of chips in a casino has become an integral part of the environment within a casino and is very popular with patrons.

Many chips are made from clay or compression molded chips. Chips can be injection molded with a special plastic or resin. The special plastic or resin can have a similar feel and sound when compared to ceramic or porcelain. Chips typically weigh between 8 grams and 14 grams.

### SUMMARY

A gaming chip can include a chip component and a clip insert. The chip component can include a plurality of tabs. The clip insert can be configured to couple to the plurality of tabs of the chip component. The clip insert can include one or more apertures. The chip component can be created using a first injection of an injection molding process. The clip insert can be coupled to the plurality of tabs after the first injection.

The gaming chip can include a second chip component. The second chip component can be injection molded over at least a portion of the chip component. A material from the second chip component can occupy a space inside the clip insert. The material can prevent the clip insert from being removed from the chip component. The one or more apertures can be positioned on an outer edge of the gaming chip.

The material from the second chip component can be injected into the one or more apertures when the second chip component is injection molded over the portion of the chip component. The clip insert, the chip component, and the second chip component can correspond to different colors. The clip insert can include at least one of: gold, silver, titanium, jade, stone, mother of pearl, crystal, wood, gemstone, or a hologram.

A gaming chip can be manufactured during a manufacturing process. A first injection can be injected. The first injection can include a plurality of affixing points. A clip insert can be positioned against a subset of the plurality of affixing points. A second injection can be injected to partially cover the clip insert and the first injection.

An RFID transponder coupled to a light emitting diode can be positioned in the clip insert. The light emitting diode can be visible on the gaming chip. The transponder can be configured to provide power to the light emitting diode when positioned within an RFID field. The plurality of affixing points can include a set of two protrusions. The clip insert can be configured to fit snug around the set of two protrusions.

The clip insert can include a window. A material can be inserted inside a recessed surface of the clip insert. The material can be visible through the window. The clip insert can include at least one security pigment. The at least one security pigment can be visible on an edge of the gaming chip after the second injection partially covers the clip insert. The at least one security pigment can also be visible from another portion of the chip, such as from the side.

A gaming chip can include a first injection, a plurality of inserts, and a second injection. The plurality of clip inserts can be configured to attach to an edge of the first injection. The second injection can be configured to prevent the clip insert from being removed from the first injection. The gaming chip can include a weighted component positioned in a center of the gaming chip. The weighted component can have a higher density than the first injection, the plurality of clip inserts, and the second injection.

Although a numerical term is used herein for the injection (e.g., “first” and “second”), it is understood that the number does not specify a fixed number of injections, also referred to as an injection mold shot. For example, one or more injections can occur before the first injection, one or more injections can occur between the first injection and the second injection, and one or more injections can occur after the second injection. Similarly, the first injection and/or second injection can include multiple injection mold shots. Further, one or more injection mold shorts can occur between injection mold shots of the first injection and/or the second injection.

The second injection can be overmolded on the first injection and the plurality of clip inserts. The second injection can be visible through at least one aperture on a respective edge of each of the plurality of clip inserts. A material from the second injection can occupy a space inside the plurality of clip inserts. The first injection can include a plurality of affixing points on the edge. The plurality of clip inserts can be configured to attach to the edge of the first injection via the plurality of affixing points. The gaming chip can be a disk shape with at least one cavity. The at least one cavity can correspond to at least one of the plurality of clip inserts.

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. Similarly, references numbers followed by an alphabetic letter represent different examples of the corresponding part.

FIG. 1 illustrates a gaming chip according to various example embodiments.

FIG. 2 illustrates a gaming chip according to various example embodiments.

FIG. 3 illustrates a gaming chip according to various example embodiments.

FIGS. 4A-4D illustrate a clip insert according to various example embodiments.

FIGS. 5A-5D illustrate a clip insert according to various example embodiments.

FIG. 6 illustrates a material for use in a clip insert according to various example embodiments.

FIG. 7A illustrates a top down view of a gaming chip according to various example embodiments.

FIG. 7B illustrates a perspective view of a gaming chip according to various example embodiments.

FIG. 7C illustrates a perspective view of a gaming chip excluding an overmold injection according to various example embodiments.

FIG. 7D illustrates a perspective view of a gaming chip excluding an overmold injection and clip inserts according to various example embodiments.

FIGS. 8A and 8B illustrate a clip insert according to various example embodiments.

FIG. 9 illustrates a gaming chip according to various example embodiments.

FIGS. 10A-10D illustrate a clip insert according to various example embodiments.

FIG. 11 illustrates an example flowchart of a process of manufacturing a gaming chip according to various embodiments of the present disclosure.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

In the following paragraphs, the embodiments are described in further detail by way of example with reference to the attached drawings. In the description, well known components, methods, and/or processing techniques are omitted or briefly described so as not to obscure the embodiments.

Casino currencies can be made of a metallic central core overmolded by a successive injection shot of different colors, formulations, and carrying different security additives. In casinos and especially on table games, the chips can be handled in stacks of chips. When in a stack, the casino personnel and the patrons can see only the edge of the chips. In order to clearly differentiate the chips while in a stack including the denomination, which can also be called sets, the chips can carry multiple inserts or colored patterns. Those differentiation elements can be brought by design during the injection molding process. Typically, those inserts of patterns will carry security additives, such as an ultra violet (UV) or infrared (IR) security additive that will glow under a special light exposure. The security additive can be used to authenticate a stack or rack of chips.

A clip insert can be added between successive injections during the injection mold process. The clip insert can be attached to an affixing point on a base component of the chip prior to injection of one or more overmolded components. An overmolded component can be injected over the clip insert and the base component. This injection can prevent the clip inserts from being removed from the chip 100. During the overmolding process, the plastic can flow inside the clip insert and fill an aperture and a gap between the clip insert and the base component. The aperture can represent an intricate design, and the material from the overmolding process can fill the aperture to create an intricate effect.

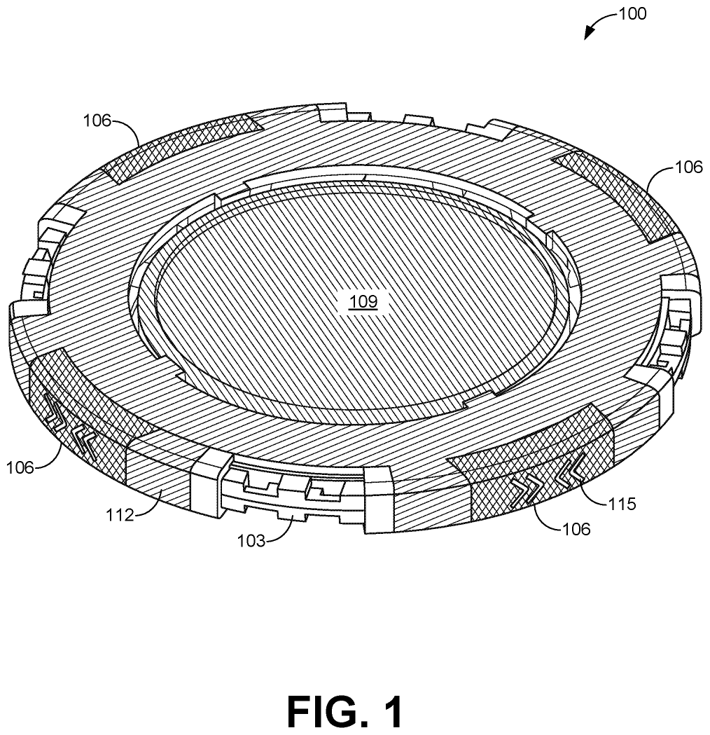

Turning now to the drawings, exemplary embodiments are described in detail. With reference to FIG. 1, shown is a gaming chip 100 according to various embodiments of the present disclosure. The chip 100 includes a chip component 103, one or more clip inserts 106, a core 109, a component 112, and potentially other elements. The component 103 can be created by an injection mold process. In some embodiments, the component 103 can correspond to a first injection mold in the process of creating the chip 100. The term “gaming chip” (or “chip”) refers to a physical object which represents cash or other value. The gaming chip can include chips, plaques, jetons, and other value tokens.

In one embodiment of manufacturing the gaming chip 100, the component 103 can be injected into an injection mold. In some embodiments, the core 109 can be part of the component 103, such that the component 103 and core 109 is injection molded in one step. In other embodiments, the core can be made of a denser material, such as, for example, metal. The core 109 can include an RFID tag. When proximate to an RFID antenna, the RFID antenna can read data from the RFID tag. The component 103 can be injection molded around the core 109 with the core 109 being surrounded by the component 103.

The clip inserts 106 can be shaped in a similar manner to an edge of the chip 100. The clip inserts 106 can be clipped on to the component 103. The component 112 can be overmolded onto the component 103, the clip inserts 106, and the core 109. The component 112 can include more than one successive overmolded injections. Each of the successive overmolded injections can correspond to a different color or formulation, include different security additives, or have other differences. The component 112 can be made from transparent, semi-transparent, or opaque materials. The security additives can include material that glows under a special light like ultraviolet light or infrared light. In some embodiments, a stack or rack of chips 100 can be authenticated by exposing the stack or rack to the special light.

The clip insert 106 can include one or more apertures 115. The apertures 115 can be in a variety of patterns or shapes. The aperture 115 can be a window with a second material enclosed within the window. The clip insert 106 can have a recessed lip along the inside of the window. The second material can similarly have a recessed edge that fits within the lip along the edge of the window of the clip insert 106. As a non-limiting example, a gold piece can be placed within the window as the second material.

The apertures 115 can be filled with material from the component 112. The overmolded component 112 can be visible through the apertures 115. As an example, the component 112 can fill the apertures 115 such that an edge surface of the clip insert 106 is flush with the component 112 within the apertures 115. The component 112 can prevent the clip inserts 106 from being removed. The clip inserts 106 can be manufactured with very fine patterns to accommodate customer requirements including any kind of letters, wording, logos, images, and other patterns.

The clip inserts 106 can be made from a variety of materials, such as, for example, synthetic, mineral, metal, gold, silver, titanium, jade, stone, mother of pearl, crystal, wood, gemstone, or other materials. The clip inserts 106 can include one or more holograms. The clip inserts 106 can be from injection molding, machining, etching, lamination, shaped with a press, or another manufacturing technique.

The materials used to make a clip insert 106 can have different densities. Because the weight of a chip 100 needs to fit within an acceptable range, using dense materials throughout a chip 100 can add excess weight. Because of the smaller size of the clip insert 106 relative to the chip 100, a denser material can be used in the clip insert 106 without substantially effecting the overall weight of the chip 100. Security pigments can be very expensive. Based on the size of the clip inserts 106 relative to the chip 100, expensive security pigments can be used more efficiently on the edge of the chip 100 by using security pigments in the clip insert 106.

The clip inserts 106 can be attached to a first shot of an injection that creates a main body of the chip 100, such as a component 103. The clip insert 106 can also be attached to any subsequent shot as long as the parts can then be overmolded to fully lock the clip insert 106 in place to prevent anyone from pulling the clip inserts 106 apart from the component 103. In some embodiments, a single clip insert 106 can be used. In other embodiments, more than one clip insert 106 can be used, for example, three, five, six, eight, or another quantity of clip inserts 106 can be used.

The clip inserts 106 can have a different color, formulation, design, or other property than the component 103 and component 112. The clip inserts 106 can also include multiple colors or other differentiating elements. As an example, a first clip insert 106 can have a UV pigment visible at 365 nm, while another clip insert 106 can have a UV pigment visible at 254 nm, and other clip inserts 106 can have an IR pigments that glow at different respective colors. By varying the materials in different clip inserts 106, an exponential number of chip configurations can be used, which can increase overall security in the chips 100. In addition, an order of different security features, such as IR and UV pigments, in different clip inserts 106 can be used to enhance security.

In the above example, the clip inserts 106 can be ordered with a UV 365 nm pigment, then a UV 254 nm pigment, then an IR visible green pigment, where a chip 100 with the IR visible green pigment clip insert 106 positioned between the UV 365 nm and 254 nm clip inserts 106 would fail a security check. A variety of security pigments can be used to create varying patterns or images on the clip inserts 106 using one or more security pigment on each clip insert 106.

In some embodiments, the clip insert 106 can be visible only from an edge of the gaming chip 100. The clip insert 106 can be one part of an annular design element visible from the side of the chip 100. The clip inserts 106 can be decorated with other printing techniques or with in mold decoration (IMD) or in mold labeling (IML). The clip inserts 106 can include a cavity or indentation along the edge to create a shaped chip 100 or a shaped edge of the chip 100.

The clip inserts 106 can be marked to carry a visible or invisible code, such as, for example, a QR code or other coding solution. The clip inserts 106 can be marked by printing, laser engraving, or another method of marking. A casino security system can validate the code or validate other security elements discussed herein. The clip inserts 106 can be made from transparent, semi-transparent, or opaque materials. The clip inserts 106 can have different textures or have a different material hardness. In some embodiments, the change in texture or hardness of the material in contrast to component 103 or 112 can be undetectable by a human finger, which can add additional security to the chip 100.

In some embodiments, the clip insert 106 can include an RFID transponder. The RFID transponder can be coupled to a currency product, one or more LEDs, or other electronic circuitry or device. The RFID transponder can generate electricity to the electronic circuitry or device in response to a special event, interrogation, or being within an RFID field.

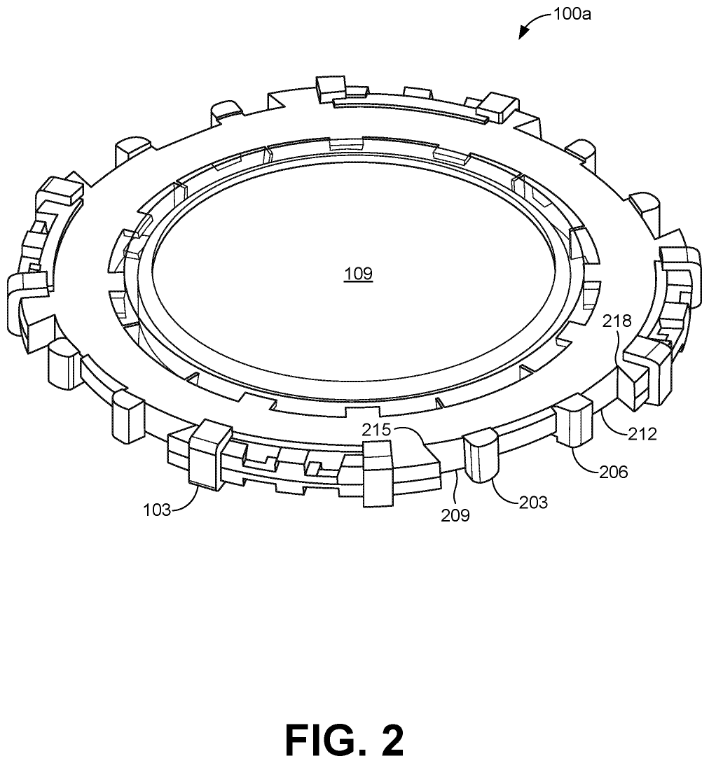

With reference to FIG. 2, shown is a component 103 of a gaming chip 100a according to various embodiments of the present disclosure. The component 103 can include one or more affixing points on which a clip insert 106 (FIG. 1) can be attached. The affixing point can include one or more tabs 203 and 206, a surface 209, a surface 212, a corner 215, a corner 218, and potentially other elements. Shown is a chip 100a after a first injection process to create the component 103 without any clip inserts 106 having been inserted.

The component 103 can be made from multiple injections of a material. In one example, the component 103 can be made from a first injection followed by one or more additional molds being injected onto the first injection. Each of the injections can correspond to a different color, formulation, include different security additives, or have other differences. The component 103 can be made from transparent, semi-transparent, or opaque materials. The security additives can include material that glows under a special light like ultraviolet light or infrared light. In some embodiments, a stack or rack of chips 100a can be authenticated by exposing the stack or rack to the special light.

The tabs 203/206 can be protrusions from the component 103 separated by a predefined distance, and the clip insert 106 can fit snug on the protrusions 203/206. In some embodiments, a distance between an outer edge of tab 203 and an outer edge of tab 206 can be greater at a point furthest from the chip 100 than at a point contacting the component 103. The greater distance at the furthest point can facilitate a tighter fit with the clip insert 106.

The surface 209 and the surface 212 can be of different lengths to ensure the clip insert 106 is inserted in a desired direction as will be shown later in more detail. The corner 215 and the corner 218 can be acute angles. The acute angles can help hold the clip insert 106 in place. The component 103 can include other crevices, such as crevices shown around the core 109. These crevices maximize the ability for an overmolded layer to bond, such as component 112 (FIG. 1).

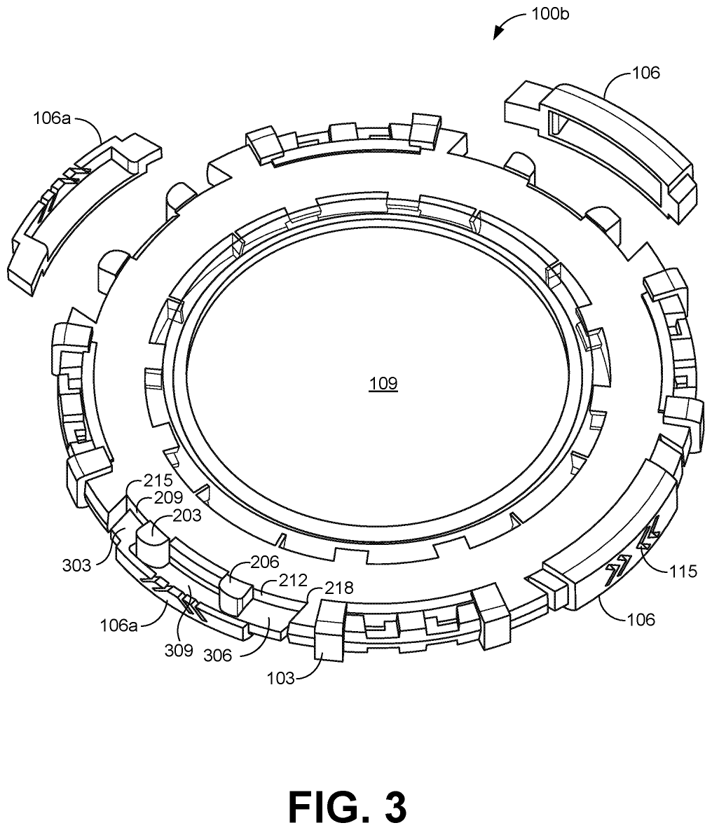

With reference to FIG. 3, shown is a portion of the gaming chip 100 according to various embodiments of the present disclosure. The chip 100 can include a component 103, one or more clip inserts 106/106a, a core 109, and potentially other elements. The clip inserts 106a can represent a cross section view of half of a clip insert 106 to show how a recessed space of the clip insert 106 fits with regard to the protrusions 203 and 206. The clip insert 106a can include a protrusion 303 and a protrusion 306. A cross-section of the protrusions 303 and 306 taken perpendicular to the chip 100b can be in the shape of a rectangle.

A proximal side of the protrusion 303 can mate against the surface 209 of the component 203. Similarly, a proximal side of the protrusion 306 can mate against the surface 212 of the component 203. A corner of the protrusion 303 can mate with the corner 215, while a corner of the protrusion 306 can mate with the corner 215. In some embodiments, the angle of the corner of the protrusions 303/306 can be the same as the angle of the corner 215 and 218. In another embodiment, the angle of the corner of the protrusions 303/306 can be less than the angle of the corner 215 and 218.

The lengths of the protrusions 303/306 can prevent improper clip insert 106 installation. As an example, the protrusion 303 can be shorter than the protrusion 306 (or vice versa), and therefore prevent the clip insert 106 from being installed upside-down. When upside-down, the longer protrusion 306 cannot fit along the shorter surface 209. Because of this mistake-proof feature, an assembler cannot install the clip inserts 106 incorrectly on the component 103. In some embodiments, the protrusion 303 and 306 can be shorter than surface 209 and 212 respectively to allow for easier insertion of the clip insert 106 during manufacturing.

When mounting each clip insert 106, the clip insert can be pressed onto each affixing point of the component 103. In some embodiments, the clip insert 106 can be held on based on the fit of the corner of protrusion 303/306 into the acute corner 215/218. When in place, the angle of less than 90 degrees for corner 215/218 can prevent the clip insert from being pulled away from the component 103 unless a force is applied. In some embodiments, the protrusion 303 can fit snuggly against the protrusion 203 and the protrusion 306 can fit snugly against the protrusion 206. As an example, a force can be required to position the protrusions 303/306 of the clip insert 106 around the outsides of protrusions 203 and 206. In yet another embodiment, the clip insert 106 can fit loosely onto the affixing point of the component 103 until the overmolding process takes place.

A cavity 309 can be formed between the component 103 and the clip insert 106a for each clip insert 106a. The cavity 309 can be surrounded on two side by the protrusions 203/206, by an edge of the component 103 on another side, and by the clip insert 106a on three sides. The one or more apertures 115 can pass through to the cavities 309.

When the one or more clip inserts 106 are in place, a material from the component 112 can be overmolded onto the chip 100. The material from the component 112 can fill the cavity 309. The material can harden to prevent the clip insert 106 from moving with respect to the component 103. The material from the component 112 can also occupy the space within the apertures 115 of the clip inserts 106.

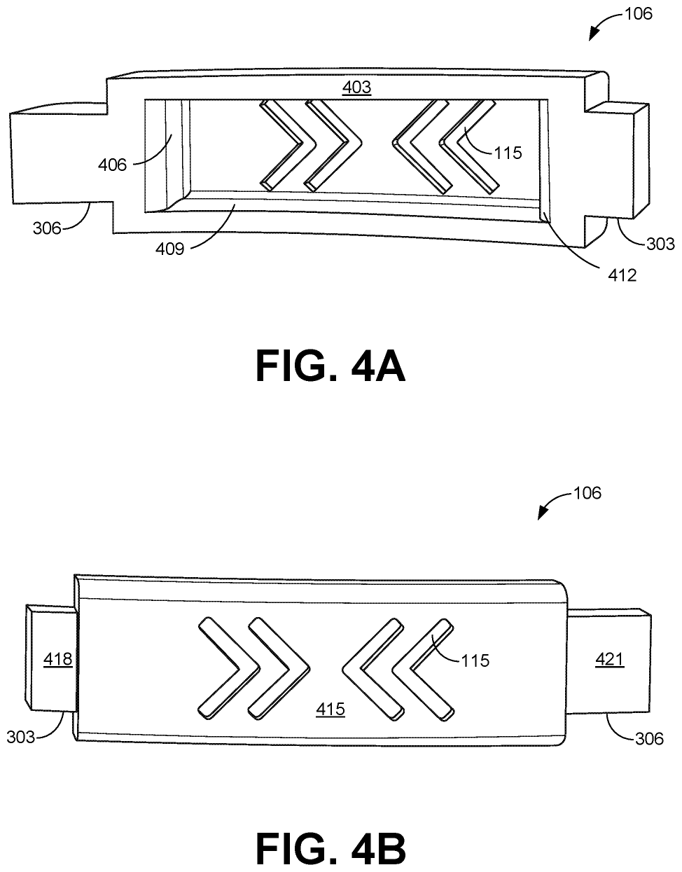

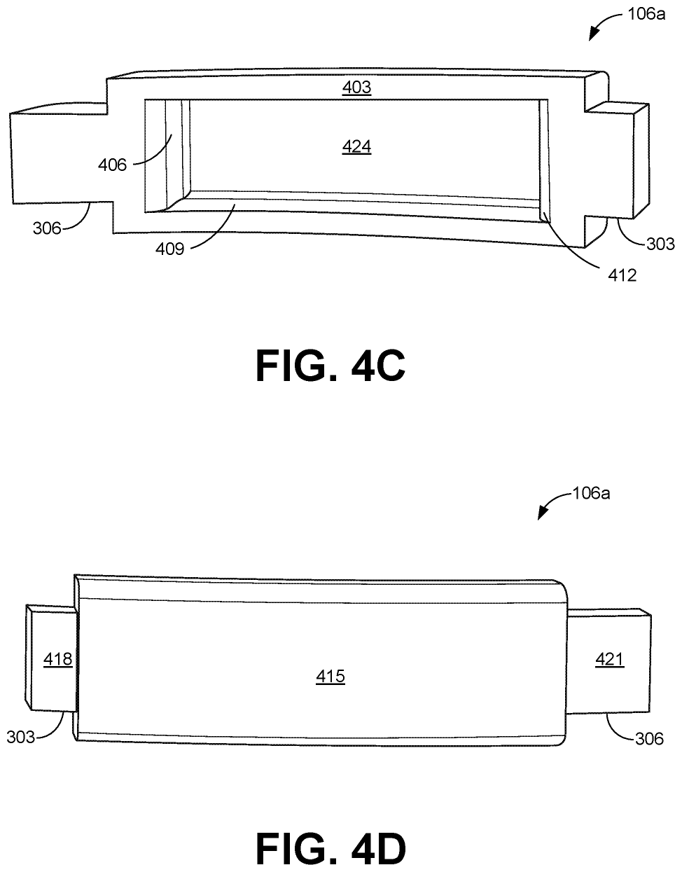

With reference to FIG. 4A, shown is a rear view of a clip insert 106 of a gaming chip 100 according to various embodiments of the present disclosure. The clip insert 106 includes protrusions 303 and 306, one or more apertures 115, a mating surface 403, walls 406/409/412, and potentially other elements. The mating surface 403 can mate against the component 103, such as, for example, against the surface 209 and 212 (FIG. 2). The wall 406 can fit against the protrusion 206, while the wall 412 can fit against the protrusion 203.

A cavity bound by walls 406, 409, 412, and a top wall (not visible) can correspond to the cavity 309. In one embodiment, the walls 406, 409, 412, or the top wall can include one or more crevices, such as indents, cavities, or apertures that can be filled with material from the component 112 during the overmolding process. The material within the crevice can better adhere the clip insert 106 to the component 112. The protrusions 303 and 306 can be of different lengths to prevent backward installation.

With reference to FIG. 4B, shown is a front view of a clip insert 106 of a gaming chip 100 according to various embodiments of the present disclosure. The clip insert 106 can include one or more apertures 115, protrusions 303 and 306, surfaces 415, 418, and 421, and potentially other elements.

After the overmolding process, material from the component 112 can cover the surfaces 418 and 421. The surface 415 can remain uncovered by the component 112. An edge of the chip 100 can include the surface 415, component 112 within the apertures 115 of clip insert 106, component 112 over the tabs 418 and 421, component 103, and other surfaces.

With reference to FIG. 4C, shown is a rear view of a clip insert 106a of a gaming chip 100 according to various embodiments of the present disclosure. The clip insert 106a includes protrusions 303 and 306, a mating surface 403, walls 406/409/412, and potentially other elements. The mating surface 403 can mate against the component 103, such as, for example, against the surface 209 and 212 (FIG. 2). The wall 406 can fit against the protrusion 206, while the wall 412 can fit against the protrusion 203.

A cavity bound by walls 406, 409, 412, and a top wall (not visible) can correspond to the cavity 309. In one embodiment, the walls 406, 409, 412, or the top wall can include one or more crevices, such as indents, cavities, or apertures that can be filled with material from the component 112 during the overmolding process. The material within the crevice can better adhere the clip insert 106a to the component 112. The protrusions 303 and 306 can be of different lengths to prevent backward installation.

The clip insert 106a can be made from more than one material. According to one example, one or more injections forms a clip insert 106 including the apertures 115. The one or more injections are performed with one or more materials including a first material proximate to the apertures 115. Then a subsequent one or more injections fills the apertures 115 with a different material (in contrast to the first material) to form the clip insert 106a.

The different material can match a color of the first material surrounding the aperture 115 such that the clip insert 106a looks to the human eye as if there was never an aperture 115 after the subsequent injections are performed. The different material can be formed by adding one or more IR and/or UV pigment to the first material. As an example, a 365 nm pigment can be added to the material that fills a first aperture 115 and a UV 254 nm pigment can be added to the material that fills a second aperture. When a 365 nm light is applied to the chip 100, the first aperture becomes visible. Similarly, when a 254 nm light is applied to the chip 100, the second aperture becomes visible.

The amount of expensive security pigments needed to create additional security features can be minimized because the apertures 115 can be made small relative to the size of the chip 100. Further, intricate designs or lettering can be made invisible to the human eye while visible to security personal using a special light. In some embodiments, information about the chip 100 can be embedded in the chip using the apertures 115. For example, the characters “$10” can be applied as an aperture 115 to be filled by the subsequent injection. When a special light (e.g., 254 nm light) is shown over the chip 100, the “$10” can be seen to confirm the chip 100 is of the denomination for ten dollars. As such, if a patron altered a ten dollar denomination chip 100 to make it look like a one hundred dollar denomination chip, the “$10” would still show when the special light is shown, and thus the security personal could easily detect the fraudulent chip.

With reference to FIG. 4B, shown is a front view of a clip insert 106 of a gaming chip 100 according to various embodiments of the present disclosure. The clip insert 106a can include protrusions 303 and 306, surfaces 415, 418, and 421, and potentially other elements. After the overmolding process, material from the component 112 can cover the surfaces 418 and 421. The surface 415 can remain uncovered by the component 112. An edge of the chip 100 can include the surface 415, component 112 over the tabs 418 and 421, component 103, and other surfaces.

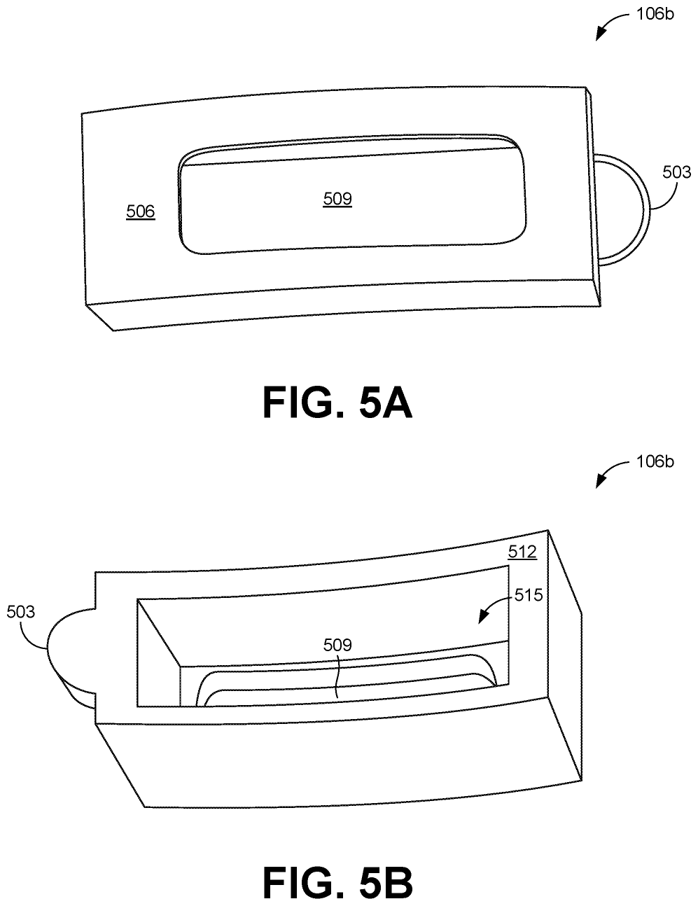

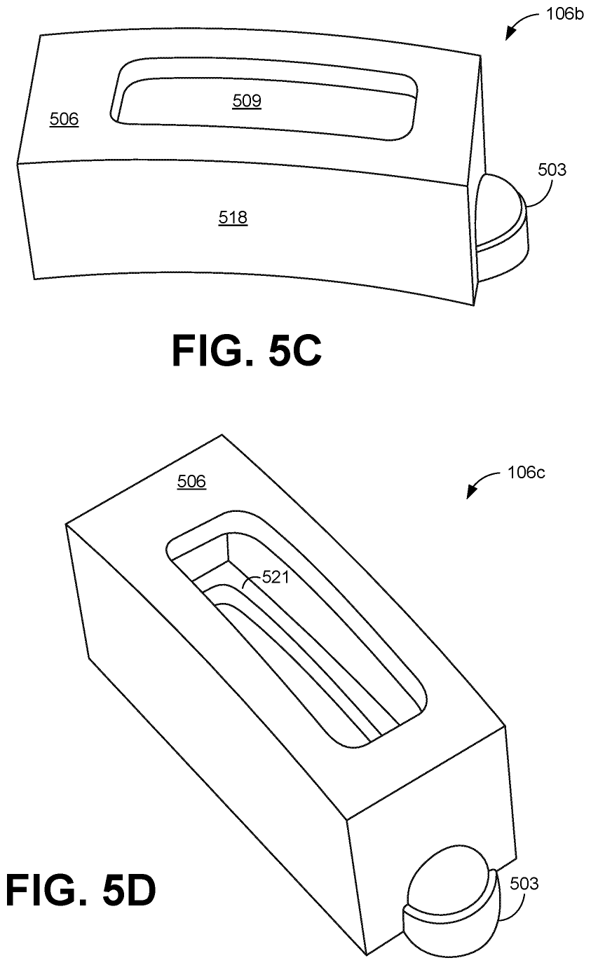

Turning to FIGS. 5A-5D, shown are different embodiments of the clip insert 106. All of the features discussed with respect to clip insert 106b and 106c in FIGS. 5A-5D can be used in combination with the clip insert 106 and vice versa. With reference to FIG. 5A, shown is a front view of a clip insert 106b of a gaming chip 100 according to various embodiments of the present disclosure. The clip insert 106b can have one or more protrusions 503, a surface 506, a window 509, and potentially other elements. A second material can be placed within the window 509. As an example, the second material can be positioned within the clip insert 106b, the clip insert 106b can be coupled to the component 103, and the component 112 can be overmolded to affix the second material within the window 509 of the clip insert 106b. After manufacturing, the surface 506 can be visible on an edge of the chip 100. Similarly, the second material can be visible on an edge of the chip 100.

In some embodiments, the clip insert 106b can include multiple windows 509 of various shapes. The multiple windows 509 can be filled by a single piece of a second material or a subset of windows 509 can each be filled by a different piece of the second material. In one example, different materials are used for each of the subset of windows 509. Each window 509 can be the shape of a rectangle, a circle, an oval, a square, a star, a character such as a letter or number, or some other shape.

Turning to FIG. 5B, shown is a rear view of a clip insert 106b of a gaming chip 100 according to various embodiments of the present disclosure. The clip insert 106b can have one or more protrusions 503, a window 509, a mating surface 512, and potentially other elements. The mating surface 512 can be positioned against the component 103 (FIG. 1) and held in place by the protrusion 503. A second material can be positioned inside of the cavity 515 of the clip insert 106b.

Turning to FIG. 5C, shown is a perspective view of a clip insert 106b of a gaming chip 100 according to various embodiments of the present disclosure. The clip insert 106b can have one or more protrusions 503, a surface 506, a window 509, a side 518, and potentially other elements. In some embodiments, the side 518 of the clip insert 106b can have a width. The side 518 can be visible from a top or bottom view of the chip 100. An amount of the clip insert 106b visible from the top or bottom is based on the width of the clip insert 106b.

In some embodiments, each side 518 of the clip insert 106b can include one or more apertures similar to apertures 115. The material from component 112 can fill the apertures on the side 518 of the clip inserts 106b. In addition, a second material inside the cavity 515 can be visible through a window in the side 518 similar to window 509.

Turning to FIG. 5D, shown is a tilted perspective view of a clip insert 106c of a gaming chip 100 according to various embodiments of the present disclosure. The clip insert 106c can include one or more protrusions 503, a surface 506, and a back wall 521. The back wall 521 can hold a second material within the clip insert 106c until the component 112 is injected onto the chip 100. In some embodiments, the back wall 521 can be a separate piece that can be clipped onto the clip insert after insertion of the second material. The back wall 521 can have cutouts made to fit around the protrusions 203 and 206 of the component 103. In some embodiments, the back wall 521 can be compressed against the protrusions 203 and 206 to assist in securing the clip insert 106c against to the component 103.

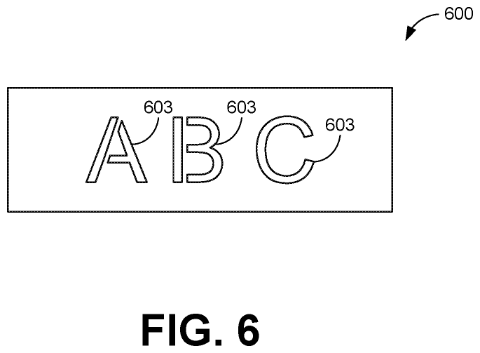

With reference to FIG. 6, shown is a material 600 according to various embodiments of the present disclosure. The material 600 can include one or more characters or elements 603, such as, for example, letters, numbers, symbols, images, or other characters/elements. The characters 603 can be etched, engraved, drawn, painted, printed, or affixed, among other mechanisms for generation. In one example, the characters 603 can be one or more gemstones embedded into the material 600.

In another example, the characters 603 can be carved out and filled with material from the component 112. In this example, the chip 100 can include a component 103 with a clip insert 106 attached. The clip insert 106 can have apertures 115 or windows. A material 600 can be visible through the apertures 115, and the overmolded component 112 can be visible within carved out sections of the material 600.

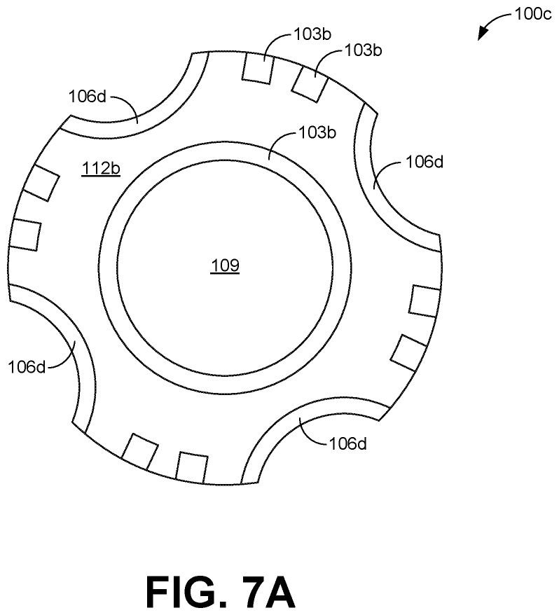

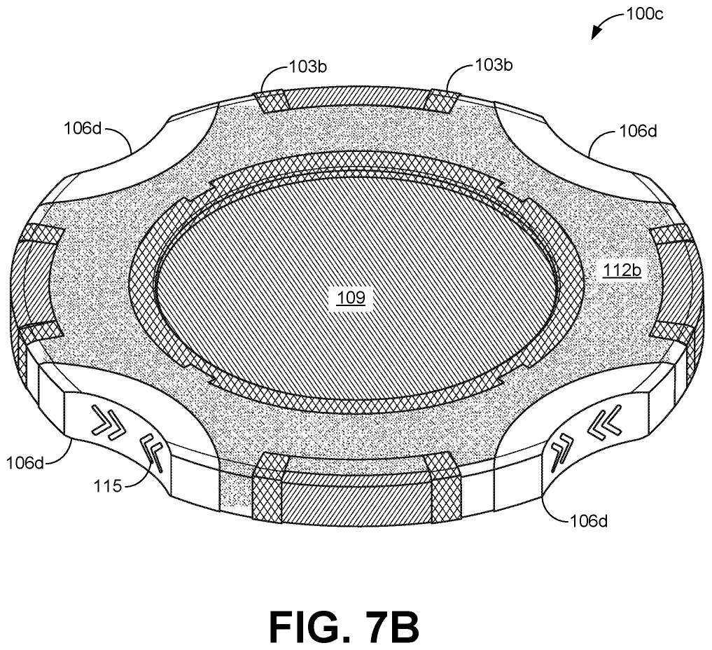

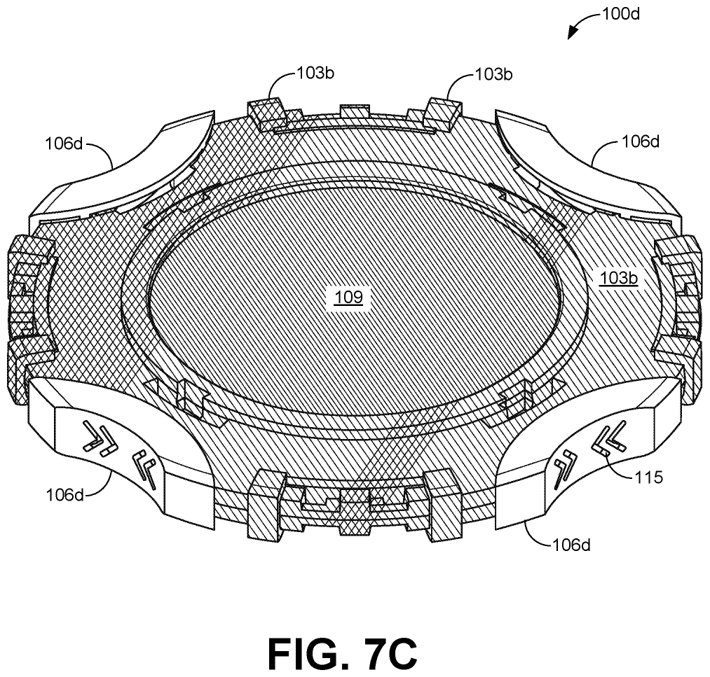

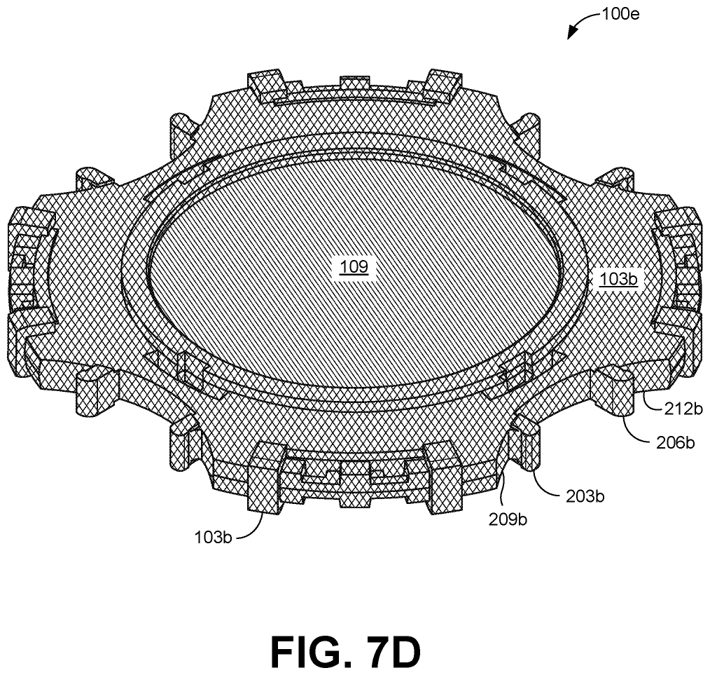

Turning to FIGS. 7A and 7B, shown is a top down view and a perspective view of a gaming chip 100c according to various embodiments of the present disclosure. The gaming chip 100c includes component 103b, one or more clip inserts 106d, a core 109, a component 112b, and potentially other elements. The gaming chip 100c illustrates a gaming chip 100 in a quasi-circular shape. The component 103b can include affixing points that the clip inserts 106d can be coupled to. The component 112b can be overmolded onto the component 103b, clip inserts 106d, and the core 109. The clip inserts 106d can include a cavity or indentation along the edge to create a shaped chip 100c. The clip inserts 106d can include one or more apertures 115.

With reference to FIG. 7C, shown is the gaming chip 100d according to various embodiments of the present disclosure. The gaming chip 100d is a gaming chip 100c excluding the component 112b. The gaming chip 100d includes component 103b, one or more clip inserts 106d, a core 109, and potentially other elements. The gaming chip 100d is formed by connecting a clip insert 106d to the component 103b. A component 112b (not shown) can be applied to the gaming chip 100d to form a gaming chip 100c. The component 112b can be overmolded onto the component 103b, clip inserts 106d, and the core 109. The clip inserts 106d can include a cavity or indentation along the edge to create a shaped chip 100d. The clip inserts 106d can include one or more apertures 115.

With reference to FIG. 7D, shown is the gaming chip 100e according to various embodiments of the present disclosure. The gaming chip 100e is a gaming chip 100d excluding the component 106d. The gaming chip 100e includes component 103b, a core 109, and potentially other elements. One or more clip inserts 106d (not shown) can be applied to the gaming chip 100e to form a gaming chip 100d.

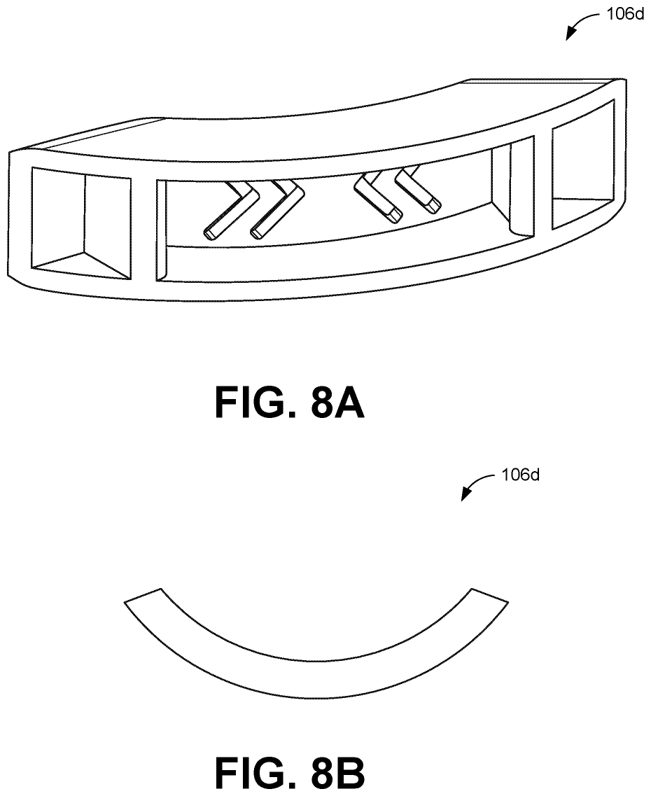

With reference to FIGS. 8A and 8B, shown is a perspective view and a top down view of a clip insert 106d according to various embodiments of the present disclosure. The clip insert 106d is a clip insert 106 except for the curved shape to account for the shape of chip 100c. The clip insert 106d can include one or more apertures, one or more windows, and can be made from more than one material in the same way as clip insert 106.

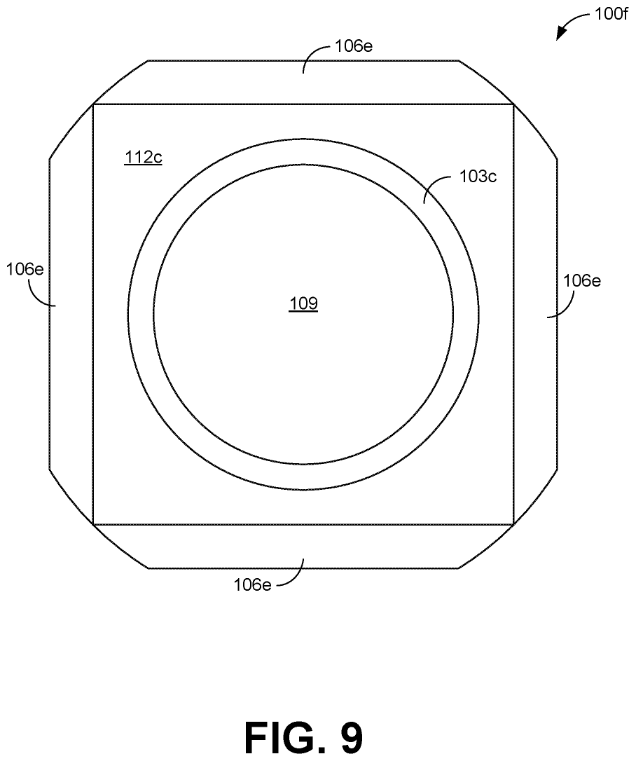

With reference to FIG. 9, shown is a gaming chip 100f according to various embodiments of the present disclosure. The gaming chip 100f includes component 103c, one or more clip inserts 106e, a core 109, a component 112c, and potentially other elements. The gaming chip 100f illustrates a gaming chip 100 in a quasi-square shape. It should be noted that gaming chips 100 can be made in a variety of shapes including square, rectangular, triangular, octagonal, trapezoidal, and other shapes. The component 103c can include affixing points that the clip inserts 106e can be coupled to. The component 112c can be overmolded onto the component 103c, clip inserts 106e, and the core 109.

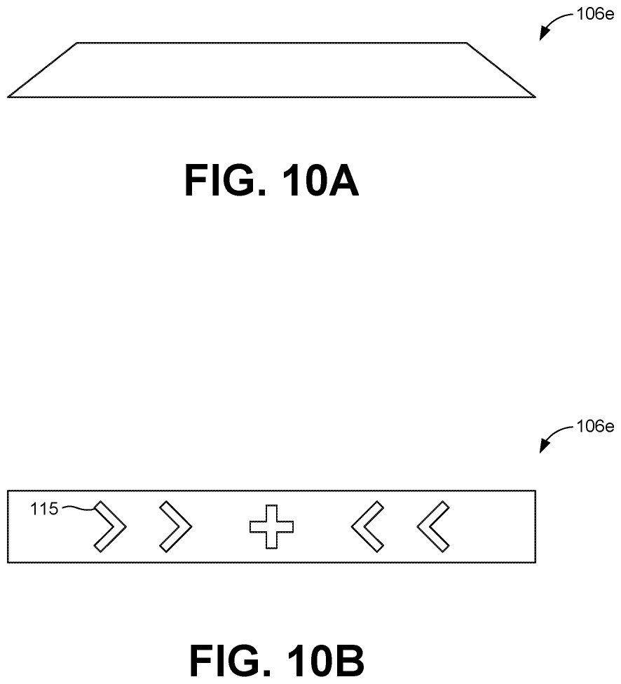

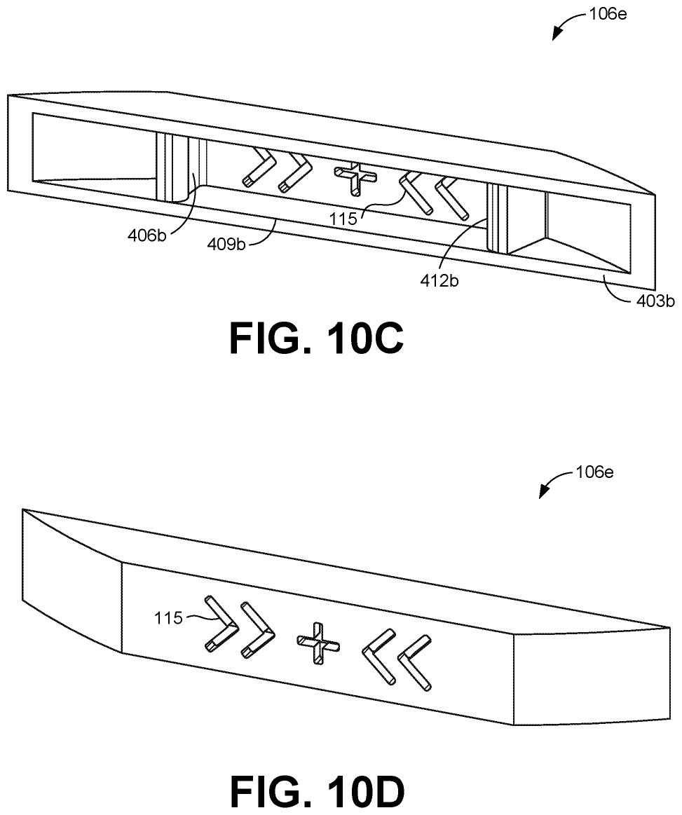

With reference to FIGS. 10A-10D, shown is a clip insert 106e from a top down view, a side view, a rear perspective view, and front perspective view according to various embodiments of the present disclosure. The clip insert 106e is a clip insert 106 except for the straighten shape to account for the shape of chip 100f. The clip insert 106e can include one or more apertures 115, one or more windows, a mating surface 403b, walls 406b/409b/412b, and potentially other elements, and can be made from more than one material in the same way as clip insert 106.

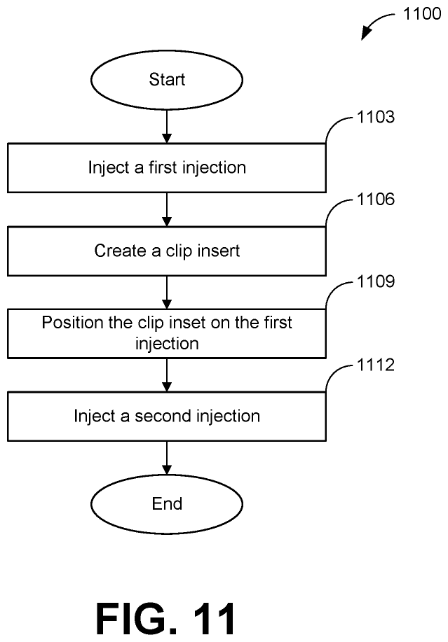

Referring next to FIG. 11, shown is a flowchart that provides one example of a manufacturing process 1100 for a gaming chip 100 according to various embodiments of the present disclosure. It is understood that the flowchart of FIG. 11 provides merely an example of a manufacturing process of one of many different gaming chip designs that may be implemented. As an alternative, the flowchart of FIG. 11 can be viewed as depicting an example of elements of a method for manufacturing the chip 100.

At box 1103, the process 1100 can include injecting a first injection. The first injection can refer to a single injection or multiple injections. For example, one or more injections can be used to create the component 103. The mold can include one or more protrusions for use in affix a clip insert 106 to the component 103.

At box 1106, the process 1100 can include creating a clip insert. For example, a clip inserts 106 can be made from a variety of materials, such as, for example, synthetic, mineral, metal, gold, silver, titanium, jade, stone, mother of pearl, crystal, wood, gemstone, or other materials. The clip inserts 106 can include one or more holograms. The clip inserts 106 can be from injection molding, machining, etching, lamination, shaped with a press, or another manufacturing technique.

The materials used to make a clip insert 106 can have different densities. Because the weight of a chip 100 needs to fit within an acceptable range, using dense materials throughout a chip 100 can add excess weight. Because of the smaller size of the clip insert 106 relative to the chip 100, a denser material can be used in the clip insert 106 without substantially effecting the overall weight of the chip 100. Security pigments can be very expensive. Based on the size of the clip inserts 106 relative to the chip 100, expensive security pigments more efficiently be used on the edge of the chip 100 by using security pigments in the clip insert 106.

At box 1109, the process 1100 can include positioning the clip insert on the first injection. A machine or person can position the clip insert 106 against component 103. The machine or person can attach the clip insert 106 onto the component 103. In one embodiment, the clip insert 106 can be pressed with a pressure against an affixing point to secure the clip insert 106 onto the component 103. The clip insert 106 can have one or more protrusions that engage one or more protrusions on the component 103. As an example, an inside edge of the protrusions 303 and 306 can engage with an outside edge of protrusions 203 and 206.

At box 1112, the process 1100 can include injecting a second injections. For example, the component 112 can be overmolded onto the component 103 and the clip insert 106. The second injection can include one or more injections. The second injection can prevent the clip inserts 106 from moving with respect to the component 103. During the overmolding process, the plastic can flow inside the clip insert and fill an aperture and a gap between the clip insert and the base component.

A phrase, such as “at least one of X, Y, or Z,” unless specifically stated otherwise, is to be understood with the context as used in general to present that an item, term, etc., can be either X, Y, or Z, or any combination thereof (e.g., X, Y, and/or Z). Similarly, “at least one of X, Y, and Z,” unless specifically stated otherwise, is to be understood to present that an item, term, etc., can be either X, Y, and Z, or any combination thereof (e.g., X, Y, and/or Z). Thus, as used herein, such phrases are not generally intended to, and should not, imply that certain embodiments require at least one of either X, Y, or Z to be present, but not, for example, one X and one Y. Further, such phrases should not imply that certain embodiments require each of at least one of X, at least one of Y, and at least one of Z to be present.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

Clause 1. A gaming chip comprising: a chip component comprising a plurality of tabs; and a clip insert configured to couple to the plurality of tabs of the chip component, the clip insert comprising at least one aperture.

Clause 2. The gaming chip of clause 21, wherein the chip component is created using a first injection of an injection molding process and the clip insert is coupled to the plurality of tabs after the first injection.

Clause 3. The gaming chip of clause 21, further comprising a second chip component, the second chip component being injection molded over at least a portion of the chip component.

Clause 4. The gaming chip of clause 23, wherein a material from the second chip component occupies a space inside the clip insert and prevents the clip insert from being removed from the chip component.

Clause 5. The gaming chip of clause 24, wherein the at least one aperture is positioned on an outer edge of the gaming chip and the material from the second chip component is injected into the at least one aperture when the second chip component is injection molded over the at least a portion of the chip component.

Clause 6. The gaming chip of clause 23, wherein the clip insert, the chip component, and the second chip component correspond to different colors.

Clause 7. The gaming chip of clause 21, wherein the clip insert comprises at least one of: gold, silver, titanium, jade, stone, mother of pearl, crystal, wood, gemstone, or a hologram.

Clause 8. A method of manufacturing a gaming chip comprising: injecting a first injection comprising a plurality of affixing points; positioning a clip insert against a subset of the plurality of affixing points; and injecting a second injection to partially cover the clip insert and the first injection.

Clause 9. The method of clause 28, further comprising positioning an RFID transponder coupled to a light emitting diode in the clip insert, the light emitting diode being visible and the transponder configured to provide power to the light emitting diode when positioned within an RFID field.

Clause 10. The method of clause 28, wherein the plurality of affixing points comprises a set of two protrusions, the clip insert configured to fit snug around the set of two protrusions.

Clause 11. The method of clause 28, wherein the clip insert comprises a window and the method further comprises inserting a material inside a recessed surface of the clip insert, the material being visible through the window.

Clause 12. The method of clause 28, wherein the clip insert comprises at least one security pigment.

Clause 13. The method of claim 32, wherein the at least one security pigment is visible on an edge of the gaming chip subsequent to the second injection to partially cover the clip insert.

Clause 14. A gaming chip comprising: a first injection; and a plurality of clip inserts configured to attach to an edge of the first injection; and a second injection configured to prevent the clip insert from being removed from the first injection.

Clause 15. The gaming chip of clause 34, further comprising a weighted component positioned in a center of the gaming chip, the weighted component having a higher density than the first injection, the plurality of clip inserts, and the second injection.

Clause 16. The gaming chip of clause 34, wherein the second injection is overmolded on the first injection and the plurality of clip inserts, the second injection being visible through at least one aperture on a respective edge of each of the plurality of clip inserts.

Clause 17. The gaming chip of clause 34, wherein a material from the second injection occupies a space inside the plurality of clip inserts.

Clause 18. The gaming chip of clause 34, wherein the first injection comprising a plurality of affixing points on the edge and the plurality of clip inserts are configured to attach to the edge of the first injection via the plurality of affixing points.

Clause 19. The gaming chip of clause 34, wherein the gaming chip is a disk shape with at least one cavity.

Clause 20. The gaming chip of clause 39, wherein the at least one cavity corresponds to at least one of the plurality of clip inserts.

1-20. (canceled)

21. A gaming chip comprising:
a first chip component comprising a plurality of tabs; and
a clip insert configured to couple to the plurality of tabs of the first chip component, the clip insert comprising at least one aperture.

22. The gaming chip of claim 21, wherein the first chip component is created using a first injection of an injection molding process and the clip insert is coupled to the plurality of tabs after the first injection.

23. The gaming chip of claim 21, further comprising a second chip component, the second chip component being injection molded over at least a portion of the first chip component.

24. The gaming chip of claim 23, wherein a material from the second chip component occupies a space inside the clip insert and prevents the clip insert from being removed from the first chip component.

25. The gaming chip of claim 24, wherein the at least one aperture is positioned on an outer edge of the gaming chip and the material from the second chip component is injected into the at least one aperture when the second chip component is injection molded over the at least the portion of the first chip component.

26. The gaming chip of claim 23, wherein respective colors of the clip insert, the first chip component, and the second chip component are different from each other.

27. The gaming chip of claim 21, wherein the clip insert comprises one or more of: gold, silver, titanium, jade, stone, mother of pearl, crystal, wood, gemstone, and a hologram.

28. A method of manufacturing a gaming chip, the method comprising:
performing a first injection that produces a first chip component comprising a plurality of affixing points;
positioning a clip insert against a subset of the plurality of affixing points; and
partially covering the clip insert and the first chip component by performing a second injection.

29. The method of claim 28, further comprising positioning a radio frequency identification (RFID) transponder coupled to a light emitting diode in the clip insert so that the light emitting diode is visible, wherein the RFID transponder is configured to provide power to the light emitting diode when the RFID transponder is positioned within an RFID field.

30. The method of claim 28, wherein the positioning of the clip insert includes snugly fitting the clip insert around a set of two protrusions of the plurality of affixing points.

31. The method of claim 28, wherein the clip insert comprises a window and the method further comprises inserting a material inside an area formed by a recessed surface of the clip insert, the material being visible through the window.

32. The method of claim 28, wherein the clip insert comprises at least one security pigment.

33. The method of claim 32, wherein the at least one security pigment is visible on an edge of the gaming chip subsequent to the second injection.

34. A gaming chip comprising:
a first injection-formed chip component;
a plurality of clip inserts attached to an edge of the first injection-formed chip component; and
a second injection-formed chip component configured to prevent the clip insert from being removed from the first injection-formed chip component.

35. The gaming chip of claim 34, further comprising a weighted component positioned in a center of the gaming chip, the weighted component having a higher density than the first injection-formed chip component, the plurality of clip inserts, and the second injection-formed chip component.

36. The gaming chip of claim 34, wherein the second injection-formed chip component is overmolded on the first injection-formed chip component and the plurality of clip inserts, and the second injection-formed chip component is visible through one or more respective apertures on a respective edge of each of the plurality of clip inserts.

37. The gaming chip of claim 34, wherein a material of the second injection-formed chip component occupies a space inside the plurality of clip inserts.

38. The gaming chip of claim 34, wherein an edge of the first injection-formed chip component comprises a plurality of affixing points, and the plurality of clip inserts are configured to attach to the edge of the first injection-formed chip component via the plurality of affixing points.

39. The gaming chip of claim 34, wherein the gaming chip is disk shaped with at least one cavity.

40. The gaming chip of claim 39, wherein the at least one cavity is in at least one of the plurality of clip inserts.
